(19) United States
(12) Patent Application Publication
(10) Pub. No.: US 2013/0262195 A1
(43) Pub. Date: Oct. 3, 2013

(54) SYSTEM FOR PRESENTING COUPONS

(71) Applicants: Jonathan Newman, Portland, OR (US); Andrew Singer, Camas, WA (US); Jon K. Lewis, Vancouver, WA (US); Terry M. Fritz, Mossyrock, WA (US); David J. Miller, Camas, WA (US); Opinderjit Bhella, Camas, WA (US)

(72) Inventors: Jonathan Newman, Portland, OR (US); Andrew Singer, Camas, WA (US); Jon K. Lewis, Vancouver, WA (US); Terry M. Fritz, Mossyrock, WA (US); David J. Miller, Camas, WA (US); Opinderjit Bhella, Camas, WA (US)

(21) Appl. No.: 13/433,764

(22) Filed: Mar. 29, 2012

(51) Int. Cl. G06Q 30/02

(52) U.S. Cl. 705/14.1

(57) ABSTRACT

An example of a system for presenting coupons is disclosed herein. An example of the system includes a user interface to collect information from a user and present coupons to the user and a non-transitory storage medium including a first database of information relating to the user collected from the user interface and further including a second database of coupons. The system also includes a coupon engine to: aggregate coupons from different sources, normalize the coupons into a common coupon data format, and store the coupons in the second database of the non-transitory storage medium. The system further includes an offer engine to analyze the coupons in the second database based in part on the collected information in the first database relating to the user to create a set of coupons for the user. An example of a method for presenting personalized coupon offers is also disclosed.

### BACKGROUND

Coupons are offered by many businesses as a way of attracting consumers to various products and services. Many consumers use coupons to receive discounts when purchasing such products and services. Sometimes consumers may even receive money, free items, or other credits towards future purchases through the use of certain types of coupons.

### BRIEF DESCRIPTION OF THE DRAWINGS

The following detailed description references the drawings, wherein:

FIG. 1 is an example of a system for presenting coupons in a personally relevant and useful order.

FIG. 2 is an expanded example of the system for presenting personalized coupons of FIG. 1.

FIG. 3 is an example of a non-transitory computer-readable storage medium.

FIG. 4 is an example of a method for presenting personalized coupon offers.

FIG. 5 is an example of further elements of the method of FIG. 4.

### DETAILED DESCRIPTION

Coupons are ubiquitous. Businesses utilize them as a way of attracting consumers to various products and services. Consumers receive coupons from many different sources including mailings, the Internet, faxes, flyers, handouts, and inserts. Saving money is of keen interest to many consumers. However, a difficulty with this process is the trouble of finding and then sorting through the hundreds or even thousands of potential coupons to find those that are relevant. Consumers may get frustrated with this process, given the time and effort required. Additionally, businesses may waste time and money by not attracting a sufficient number of consumers through this process.

A system that could sift through a large collection of coupons, using customer specific information and preferences, to find relevant coupons would be beneficial to both consumers and businesses. Such a system could allow customer to find, select, discard, print and utilize coupons by only having to sort through a very small list that is customized for that particular user in a way that is quick and effective. Preferably, this system could also remember what a customer had previously selected, discarded, and printed, and then utilize that history to learn which coupons will likely be relevant to the customer in the future.

As used herein, the terms “coupon”, “coupons”, “coupon offer” and “coupon offers” refer to an offer and/or discount for a good or service. For example, the coupon may be a discount for the grocery store, a department store, or a restaurant, such as a dollar amount off items or a price reduction by a specific percentage. The coupon may also be an offer for a free item, such as a buy one get one free offer. The coupon may additionally be an offer to receive money or other credit based on a purchase or other action.

As used herein, the terms “non-transitory storage medium” and non-transitory computer-readable storage medium” refer to any media that can contain, store, or maintain programs, information, and data. Non-transitory storage medium and non-transitory computer-readable storage medium may include any one of many physical media such as, for example, electronic, magnetic, optical, electromagnetic, or semiconductor media. More specific examples of suitable non-transitory storage medium and non-transitory computer-readable storage medium include, but are not limited to, a magnetic computer diskette such as floppy diskettes or hard drives, a magnetic tape, a random access memory (RAM), a read-only memory (ROM), an erasable programmable read-only memory, a flash drive, a compact disc (CD), or a digital video disk (DVD).

As used herein, the term “processor” refers to an instruction execution system such as a computer/processor based system, an Application Specific Integrated Circuit (ASIC), or a hardware and/or software system that can fetch or obtain the logic from a non-transitory storage medium or a non-transitory computer-readable storage medium and execute the instructions contained therein.

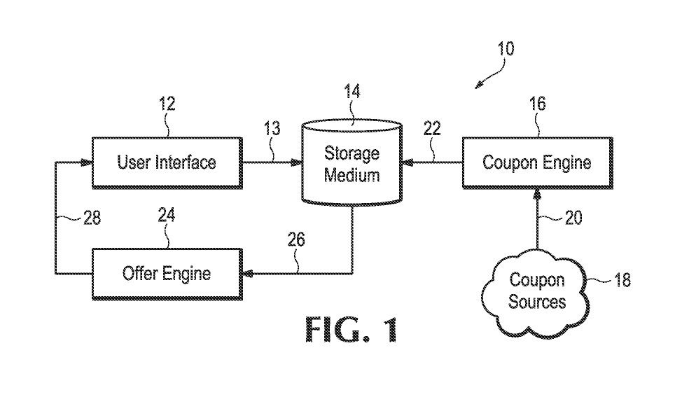

An example of a system 10 for presenting coupons in a personally relevant and useful order which is directed at achieving these objectives is shown in FIG. 1. As can be seen in FIG. 1, includes a user interface 12 to collect information from a user and also to present coupons to the user. User interface 12 can be any type of interface that allows users of system 10 to enter information and receive coupons. For example, user interface 12 can include a web-based interface utilized by a computer, terminal, mobile device, personal digital assistant, tablet, camera, etc. As another example, user interface 12 can include a peripheral-based interface that allows users to scan, fax, or e-mail information to system 10 and print coupons for use, such as a multi-function printer.

System 10 also includes a non-transitory storage medium 14 that includes a first database of information relating to the user collected via user interface 12 and stored therein, as indicated by arrow 13. Non-transitory storage medium 14 also includes a second database of coupons. Although the first and second databases in this example of system 10 are located on single non-transitory storage medium 14, it is to be understood that in other examples, the first and second databases may be on separate non-transitory storage media or each database may be on multiple non-transitory storage media depending on a variety of factors such as the amount of information and the need for back-up redundancy.

As can be seen in FIG. 1, system 10 additionally includes a coupon engine 16 that aggregates, collects, and/or receives coupons from a variety of sources 18, as indicated by arrow 20, such as internet sites or e-mails. Coupon sources 18 may also include mailings, faxes, flyers, handouts, and inserts received by the operators of system 10 that have been digitally converted into electronic data, for example, by scanning. Coupon engine 16 also normalizes or homogenizes these coupons into a common or system coupon data format for use by system 10. This common coupon data format can be any type of data format that is sufficiently uniform to allow processing and use by system 10, as described herein. Coupon engine 16 additionally stores the coupons in the second database of non-transitory storage medium 14, as indicated by arrow 22.

As can also be seen in FIG. 1, system 10 further includes an offer engine 24 that analyzes the coupons in the second database of non-transitory storage medium 14 based in part on the collected information in the first database of non-transitory storage medium 14 relating to the user, as indicated by arrow 26. Subsequent to this analysis, offer engine 24 creates a set of coupons for the user to interact with via user interface 12, as indicated by arrow 28.

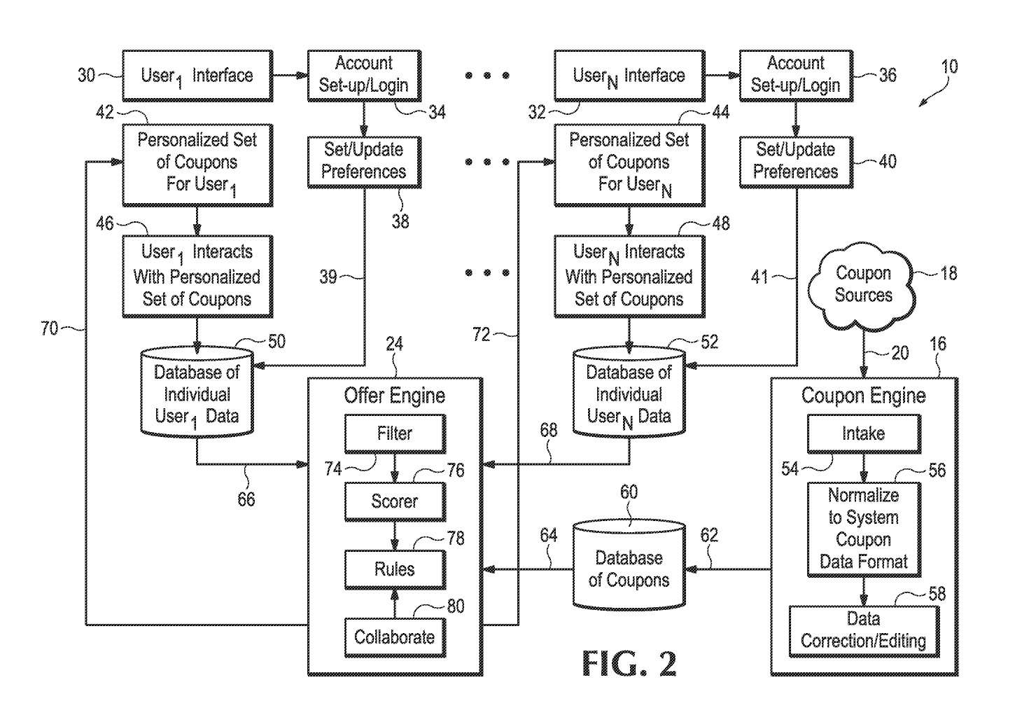

An expanded example of system 10 is shown in FIG. 2. As can be seen in FIG. 2, system 10 can provide any number of user interfaces, as represented by user₁ interface 30 through user_{N} interface 32. In this example, each user of system 10 initially establishes an account or subsequently logs-in, as indicated by blocks 34 and 36. During initial account set-up each user provides information regarding his or her individual preferences for the types of coupons he or she is interested n receiving (e.g., electronics-related, restaurant-related, grocery-related, entertainment-related, etc), as indicated by blocks 38 and 40. These preferences may be subsequently updated by the users, as also indicated by blocks 38 and 40. System 10 then stores this information or data in database 50 or 52 (described in more detail below), as indicated by respective arrows 39 and 41. System 10 may also utilize other information regarding users (e.g., age, gender, location, income, household composition, etc.) in generating coupon offers for them.

System 10 then generates an initial set of coupons in a personally relevant and useful order for user₁, as indicated by block 42, as well as all other users from user1 through user_{N}, as indicated by block 44. Each user may then interact with his or her individual initial personalized set of coupons, as indicated by block 46, as well as all other users from user1 through user_{N}, as indicated by block 48. Such interaction may take any number of a variety of forms such as printing one or more coupons, skipping one or more coupons, selecting or “clipping” one or more coupons, or deleting one or more coupons. These individual user interactions with their initial personalized set of coupons are collected and recorded in first database 50 for user₁ through database 52 for user_{N}, as information relating to these users. Other information relating to users of system 10 may also be stored in databases 50 through 52, such as the user profiles and preferences previously entered, as indicated by blocks 38 and 40. Although databases 50 through 52 are illustrated as residing on separate non-transitory storage media in FIG. 2, it should be noted that one or more of these databases may reside on the same non-transitory storage medium.

As discussed above, coupon engine 16 aggregates, collects, and/or receives coupons from a variety of sources 18, as indicated by arrow 20, such as internet sites or e-mails. Coupon sources 18 may also include mailings, faxes, flyers, handouts, and inserts received by the operators of system 10 that have been digitally converted into electronic data, for example by scanning. These various methods of initial coupon intake are generally represented by block 54. Coupon engine then normalizes or homogenizes these coupons into a system coupon data format for use by system 10, as indicated by block 56. This system coupon data format can be any type of data format that is sufficiently uniform to allow processing and use by system 10, as described herein. Coupon engine 16 next edits the coupon data to correct things such as typos and duplicate offers (e.g., “ABCs Pizza and ABC's Pizza), as indicated by block 58. Coupon engine 16 finally stores the coupons in database of coupons 60 of a non-transitory storage medium, as indicated by arrow 62.

The above-described process engaged in by coupon engine 16 to acquire and process coupons from sources 18 can occur on a periodic bases (e.g., daily, weekly, etc.) for each individual source. Alternatively, it can occur at different periods for different sources (daily for internet-based sources and weekly for paper-based sources). Additionally, it can be initiated on an off-period basis for one or more different sources by an administrator of system 10.

As also discussed above, offer engine 24 analyzes the coupons in database of coupons 60, as indicated by arrow 64, based in part on the collected information stored in databases 50 through 52 relating to the users_{1 through N} of system 10, as indicated by arrows 66 and 68. Subsequent to this analysis, offer engine 24 creates a new or revised set of coupons in a personally relevant and useful order for each of the users of system 10 to interact with via user interfaces 30 through 32, as indicated by arrows 70 and 72. This analysis for user₁ through user_{N} can occur at different times or simultaneously. It can also occur multiple times over users' interaction with system 10. That is, offer engine 24 can reanalyze one or more of databases 50 through 52 and database 60 any number of times to provide updated, new or revised sets of personalized coupons for any or all of the users of system 10. This reanalysis can occur on a periodic basis, each time a user logs-in to system 10, and/or it can be initiated by an administrator of system 10.

As can be seen in FIG. 2, offer engine 24 includes a variety of components including a filter 74, a scorer 76, and one or more rules 78. Filter 74 is responsible for removing coupons that are inapplicable to a particular user. Filter 74 may include one or more sub-filters linked together such that all coupon offers must flow through each of them in order to determine applicability to a particular user of system 10. Each of these sub-filters can serve a specific purpose or function of attempting to remove irrelevant coupons. For example, one sub-filter may examine explicit preferences of a user and remove coupons relating to items that a user specifically does not want to receive, such as alcohol, baby items, etc. Another sub-filter may remove coupons relating to items that are irrelevant to a user based on location (e.g. customer lives outside the region where the coupon offer is valid). The number of sub-filters is dynamic and each sub-filer can be changed or added to based on a user-by-user basis or on a system-wide basis, depending on the particular objectives of system 10.

Scorer 76 of offer engine 24 includes a collection of scoring modules, each of which is tuned to a specific task. Each of these modules may return a normalized score which are then individually weighted to produce a cumulative score that indicates coupon offer relevance for a particular user of system 10 (e.g., a relevancy score). For example, one scoring module may utilize user category preferences. Another scoring module may utilize specific keywords in coupons previously printed or selected by the particular user. Another scoring module may utilize categories the user had previously printed or selected. Another scoring module may utilize attribute groups and make inferences about relevancy based on previously printed or selected coupons and/or whether the particular user fits into an attribute class (e.g. pet owner, parent with young children, customer who likes to eat out, etc). The number of scoring modules of scorer 76 is dynamic and each scoring module can be change or added to based on a user-by-user basis or on a system-wide basis, depending on the particular objectives of system 10.

Once all coupon offers have passed through filer 74 and scorer 76, inapplicable coupon offers are removed and the remaining coupon offers are sorted based on their relevancy score. The one or more rules 78 are responsible for additional organizing, grouping, and placing of the remaining coupon offers within a set of coupons provided to a user based on specific rules and the relevancy score list. An example of a rule would be ensuring at least two (2) “big deal” coupon offers are presented to each user, even though such coupon offers might not have been near the top of the sorted relevancy scored list. Another rule might be that a children's theme park coupon offer shouldn't be next to an alcoholic beverage coupon offer. These rules typically enforce layout requirements, but can also affect specific needs (e.g. a new business may pay the operator of system 10 to ensure that 75% of all users see a specific offer in a given time period). It is these rules that enable system 10 to provide advertiser based targeting of offers to specific users or groups of users.

Offer engine 24 may include an additional element or component indicated by collaborate block 80 in FIG. 2. Collaborate element or component 80 of offer engine 24 utilizes information stored in two or more databases of system 10 relating to t or more users to determine similar or identical characteristics or attributes of such users (e.g., zip code, age, household, etc.) to generate a common coupon that is within each of the sets of coupons delivered to the users. For example, a common coupon relating to the opening of a new business within a particular zip code may be provided to all users of system 10 that have the same zip code. Another example would be to provide “hot” offers in a specific zip code (e.g. most people in Portland, Oreg. printed the 10% off any raincoat offer).

Each of the resulting sets of coupons generated by offer engine 24 are ordered based on relevancy to a particular individual user. Additionally, offer engine 24 helps ensure the resulting sets of generated coupons meet specific business objectives using specific rules. Each set of coupon offers can be presented to a user in a variety of ways. These include, for example, a printed index sheet that allows a user to select coupon offers by filling in bubbles and then transmit this index sheet to system 10 (e.g., by scanning or faxing), a web page that displays coupon offers to the user in a variety of dynamic and/or list based styles, as well as on mobile platforms like smart phones and tablet devices.

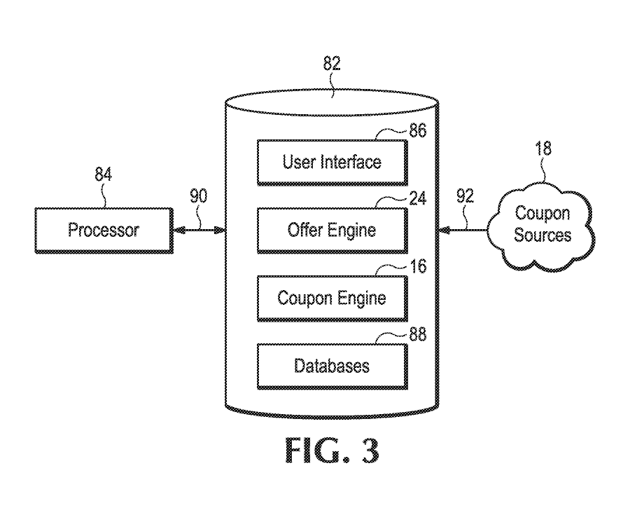

An example of a non-transitory computer-readable storage medium 82 is shown in FIG. 3. Non-transitory computer-readable storage medium 82 includes instructions that, when executed by processor 84, cause processor 84 to provide the features and functionality of system 10, described above. As can be seen in FIG. 3, non-transitory computer-readable storage medium 82 includes instructions for providing a user-interface 86 like user-interfaces 12 and 30 through 32 described above. Non-transitory computer-readable storage medium 82 also includes instructions for both coupon engine 16 and offer engine 24. Non-transitory computer-readable storage medium 82 additionally includes instructions and space for providing one or more databases 88 of the type provided by storage medium 14 and databases 50 through 52.

As can be seen in FIG. 3, non-transitory computer-readable storage medium 82 is coupled to processor 84, as indicated by double-headed arrow 90. This allows processor 84 to receive the above-described instructions from non-transitory computer-readable storage medium 82, as well as information and data stored within one or more databases 88. Processor 82 may also store data and information on non-transitory computer-readable storage medium 82. As can also be seen in FIG. 3, non-transitory computer-readable storage medium 82 is connected to coupon sources 18, as indicated by arrow 92, so that coupon 16 may receive coupon offers, as discussed above. Although non-transitory computer-readable storage medium 82 is illustrated in FIG. 3 as a single device, it is to be understood that it may also comprise more than one non-transitory storage medium.

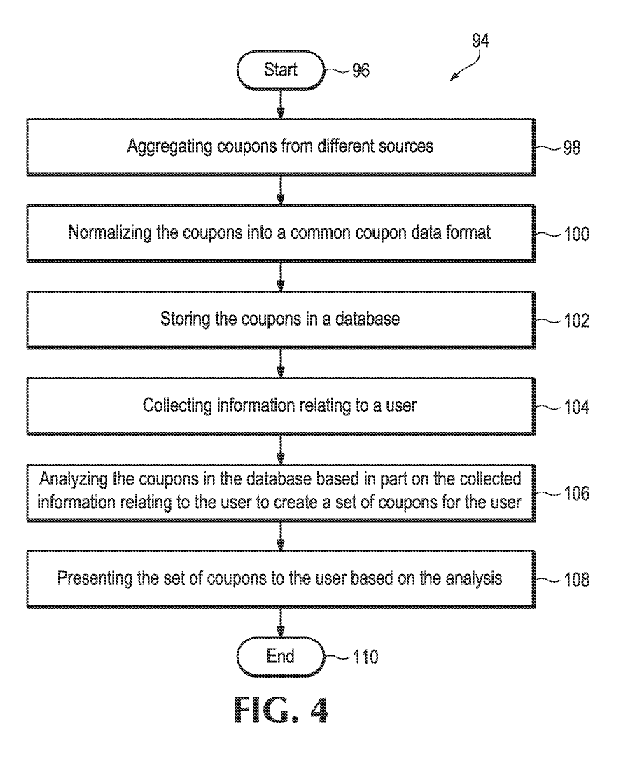

An example of a method for presenting personalized coupon offers 94 is shown in FIG. 4. As can be seen in FIG. 4, method 94 starts 96 by aggregating coupons from different sources, as indicated by block 98, then normalizing these coupons into a common coupon data format, as indicated by block 100, and storing the coupons in a database, as indicated by block 102. Method 94 continues by collecting information relating to a user, as indicated by block 104, analyzing the coupons in the database based in part on the collected information relating to the user to create a set of coupons for the user, as indicated by block 106, and presenting the set of coupons to the user based on the analysis, as indicated by block 108, in any of a variety ways, such as an Internet-based display that provides a user several ways to view offers (e.g., sorted by relevancy, filtered by category, sorted by how new the offer is, etc.). As another example, an index sheet representation may be printed that includes two columns of offers, one column for national offers (e.g. offers from manufacturers of durable goods) and the other column for local offers (e.g. restaurants, local stores, etc). As a further example, mobile applications may present a reduced set of offers due to display space constraints. Method 94 then ends 110.

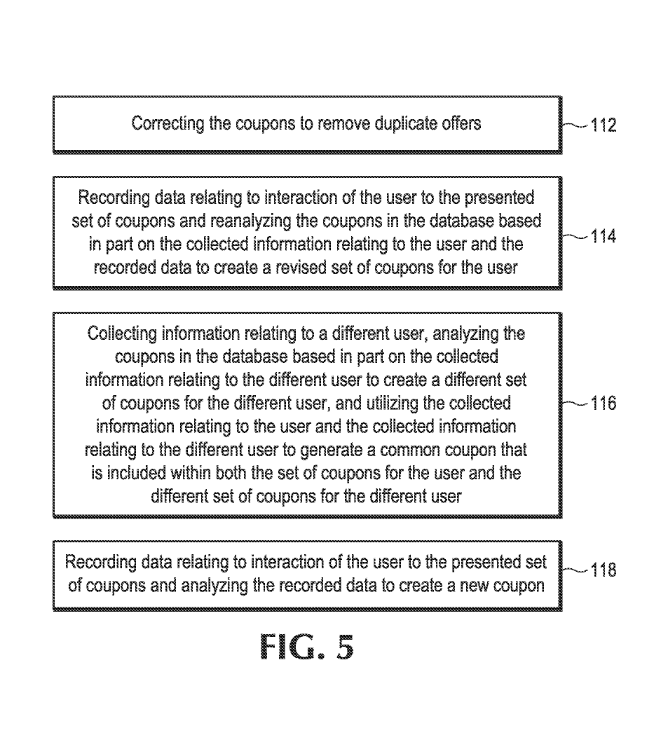

Method 94 may additionally include one or more of the following additional elements. Method 94 may include the additional element of correcting the coupons to remove duplicate offers, as indicated by block 112 in FIG. 5. Method 94 may also or alternatively include the additional element of recording data relating to interaction of the user to the presented set of coupons and reanalyzing the coupons in the database based in part on the collected information relating to the user and the recorded data to create a revised set of coupons for the user, as indicated by block 114. Method 94 may additionally or alternatively include the elements of collecting information relating to a different user, analyzing the coupons in the database based in part on the collected information relating to the different user to create a different set of coupons for the different user, and utilizing the collected information relating to the user and the collected information relating to the different user to generate a common coupon that is included within both the set of coupons for the user and the different set of coupons for the different user, as indicated by block 116 in FIG. 5. Method 94 may additionally or alternatively include the element of recording data relating to interaction of the user to the presented set of coupons and analyzing the recorded data to create a new coupon, as indicated by block 118 in FIG. 5.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. For example, the offer engine may additionally analyze the coupons stored in a database based in part on additional collected information relating to a different user to create a set of coupons for the user. As another example, data may be recorded relating to interaction of a user to a present set of coupons. This recorded data may then be utilized create a new coupon that can be stored on the system and presented to the user. As an additional example, the offer engine may utilize both positive and negative feedback from a user's actions in the analysis of which coupons to present to the user (e.g., printing/clipping offers repeatedly from a given category or a given brand would cause positive reinforcement behavior for that category, brand and/or offer, while repeatedly skipping/avoiding offers would cause negative reinforcement behavior for that category, brand, and/or offer). As a further example, the offer engine may include a filter or rule relating to coupon expiration behavior (e.g., if a user has clipped an offer that is sitting in queue to be printed, and that offer expires before it can be printed, the offer engine will find an equivalent offer, if one exists, to replace that expired offer, possibly notifying the user and/or asking if this “replaced” offer should be added to his or her queue. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A system for presenting coupons, comprising:
a user interface to collect information from a user and present coupons to the user;
a non-transitory storage medium including a first database of information relating to the user collected from the user interface and further including a second database of coupons;
a coupon engine to:
aggregate coupons from different sources,
normalize the coupons into a common coupon data format, and
store the coupons in the second database of the non-transitory storage medium; and
an offer engine to analyze the coupons in the second database based in part on the collected information in the first database relating to the user to create a set of coupons for the user.

2. The system of claim 1, wherein the a user interface collects information relating to interaction of the user with the set of coupons and further wherein the offer engine reanalyzes the coupons in the second database in part based on the collected information from the user relating to interaction of the user with the presented set of coupons to create a revised set of coupons for the user.

3. The system of claim 1, wherein the coupon engine further corrects the coupons to remove duplicate offers.

4. The system of claim 1, wherein:
the user interface collects information from a different user,
the non-transitory storage medium includes a third database of information relating to the different user collected from the user interface,
the offer engine analyzes the coupons in the second database based in part on the collected information in the third database relating to the different user to create a different set of coupons for the different user, and
the offer engine utilizes the collected information in the first database relating the user and the collected information in the third database relating the different user to generate a common coupon that is included within both the set of coupons for the user and the different set of coupons for the different user.

5. The system of claim 1, wherein the user interface comprises one of a web-based interface and a peripheral-based interface.

6. The system of claim 1, wherein the offer engine analyzes the coupons in the second database based in part on the collected information in the first database from the user in the first database to create a set of coupons for the user by:
filtering the coupons in the second database to remove coupons that are inapplicable to the user based on the collected information in the first database relating to the user to create a set of coupons for the user,
scoring the set of coupons based on the collected information in the first database relating to the user to generate a relevancy score for the user for each of the coupons in the set of coupons, and
prioritizing the set of coupons in a particular order based on at least one rule.

7. The system of claim 1, wherein the offer engine analyzes the coupons in the second database based in part on additional collected information relating to a different user to create a set of coupons for the user.

8. A non-transitory computer-readable storage medium including instructions executable by a processor, the non-transitory computer-readable storage medium, comprising:
instructions for aggregating coupons from different sources;
instructions for normalizing the coupons into a common coupon data format;
instructions for storing the coupons in a database;
instructions for collecting individual information from a user;
instructions for analyzing the coupons in the database based in part on the collected individual information from the user to create a set of coupons for the user; and
instructions for presenting the set of coupons to the user based on the analysis.

9. The non-transitory computer-readable storage medium of claim 8, further comprising instructions for correcting the coupons to remove duplicate offers.

10. The non-transitory computer-readable storage medium method of claim 8, further comprising instructions for recording data relating to interaction of the user to the presented set of coupons and instructions for reanalyzing the coupons in the database based in part on the collected individual information from the user and the recorded data to create a revised set of coupons for the user.

11. The non-transitory computer-readable storage medium of claim 8, wherein the instructions for analyzing the coupons in the database based in part on the collected individual information from the user to create a set of coupons for the user comprises instructions for filtering the coupons in the database to remove coupons that are inapplicable to the user thereby creating the set of coupons for the user.

12. The non-transitory computer-readable storage medium of claim 8, wherein the instructions for analyzing the coupons in the database based in part on the collected individual information from the user to create a set of coupons for the user comprises instructions for scoring the set of coupons to generate a relevancy score for the user for each of the coupons in the set of coupons.

13. The non-transitory computer-readable storage medium of claim 8, wherein the instructions for analyzing the coupons in the database based in part on the collected individual information from the user to create a set of coupons for the user comprises instructions for organizing the set of coupons based on at least one rule that places the coupons within the set of coupons in a particular order.

14. The non-transitory computer-readable storage medium of claim 8, further comprising:
instructions for collecting individual information from a different user,
instructions for analyzing the coupons in the database based in part on the collected individual information from the different user to create a different set of coupons for the different user, and
instructions for utilizing the collected individual information from the user and the collected individual information from the different user to generate a common coupon that is included within both the set of coupons for the user and the different set of coupons for the different user.

15. A method for presenting personalized coupon offers, comprising:
aggregating coupons from different sources;
normalizing the coupons into a common coupon data format;
storing the coupons in a database;
collecting information relating to a user;
analyzing the coupons in the database based in part on the collected information relating to the user to create a set of coupons for the user; and
presenting the set of coupons to the user based on the analysis.

16. The method of claim 15, further comprising correcting the coupons to remove duplicate offers.

17. The method of claim 15, further comprising recording data relating to interaction of the user to the presented set of coupons and reanalyzing the coupons in the database based in part on the collected information relating to the user and the recorded data to create a revised set of coupons for the user.

18. The method of claim 15, wherein analyzing the coupons in the database based in part on the collected information relating to the user to create a set of coupons for the user comprises filtering the coupons in the database to remove coupons that are inapplicable to the user thereby creating the set of coupons for the user.

19. The method of claim 15, wherein analyzing the coupons in the database based in part on the collected information relating to the user to create a set of coupons for the user comprises scoring the set of coupons to generate a relevancy score for the user for each of the coupons in the set of coupons.

20. The method of claim 15, wherein analyzing the coupons in the database based in part on the collected information relating to the user to create a set of coupons for the user comprises organizing the set of coupons based on at least one rule that places the coupons within the set of coupons in a particular order.

21. The method of claim 15, further comprising:
collecting information relating to a different user,
analyzing the coupons in the database based in part on the collected information relating to the different user to create a different set of coupons for the different user, and
utilizing the collected information relating to the user and the collected information relating to the different user to generate a common coupon that is included within both the set of coupons for the user and the different set of coupons for the different user.

22. The method of claim 15, further comprising recording data relating to interaction of the user to the presented set of coupons and analyzing the recorded data to create a new coupon.
